(19) United States
(12) Patent Application Publication
(10) Pub. No.: US 2022/0044897 A1
(43) Pub. Date: Feb. 10, 2022

(54) AUXILIARY CONTACT UNIT

(71) Applicant: FUJI ELECTRIC FA COMPONENTS & SYSTEMS CO., LTD., Konosu-shi (JP)

(72) Inventors: Kouetsu TAKAYA, Konosu-shi (JP); Koumei HAZAWA, Konosu-shi (JP); Masashi SEKIYA, Kawagoe-city (JP)

(73) Assignee: FUJI ELECTRIC FA COMPONENTS & SYSTEMS CO., LTD., Konosu-shi (JP)

(21) Appl. No.: 17/509,649

(22) Filed: Oct. 25, 2021

Related U.S. Application Data
(63) Continuation of application No. PCT/JP2020/007123, filed on Feb. 21, 2020.

(30) Foreign Application Priority Data
Nov. 18, 2019 (JP) 2019-208013

(51) Int. Cl. H01H 50/18; H01H 50/04; H01H 50/56

(52) U.S. Cl. CPC H01H 50/18; H01H 50/56; H01H 50/04

(57) ABSTRACT

An auxiliary contact unit including: a pair of fixed contact pieces; a movable contact piece arranged in a contactable and separable manner to and from the pair of fixed contact pieces; an auxiliary contact support configured to hold the movable contact piece and move in conjunction with opening/closing operation of an electromagnetic contactor; and a unit case configured to house the pair of fixed contact pieces, the movable contact piece, and the auxiliary contact support in a housing portion formed with joining portions of respective ones of a first case member and a second case member opposed to each other, wherein the joining portions of the respective ones of the first and second case members are air-tightly joined to each other.

### CROSS-REFERENCE TO RELATED APPLICATION

This application is a continuation application filed under 35 U.S.C. § 111(a) of International Patent Application No. PCT/JP2020/007123, filed on Feb. 21, 2020, the contents of which are incorporated herein by reference.

### TECHNICAL FIELD

The present invention relates to an auxiliary contact unit, and particularly relates to a technology that is effectively applied to an auxiliary contact unit attached to a side surface of an electromagnetic contactor.

### BACKGROUND ART

Attachments (optional components) of an electromagnetic contactor include an auxiliary contact unit. The auxiliary contact unit is an attachment configured to output a signal of an auxiliary contact, which operates in conjunction with opening/closing operation (closing operation and cut-off operation) of the electromagnetic contactor, to an external electronic control circuit or the like, and the types of the auxiliary contact unit include a head-on type in which the auxiliary contact unit is externally attached to the top of the body of the electromagnetic contactor and a side-on type in which the auxiliary contact unit is externally attached to a side surface of the body of the electromagnetic contactor.

A side-on type auxiliary contact unit includes a pair of fixed contact pieces, a movable contact piece arranged in a contactable and separable manner to and from the pair of fixed contact pieces, an auxiliary contact support configured to hold the movable contact piece and move in conjunction with opening/closing operation of the electromagnetic contactor, and a unit case configured to house the pair of fixed contact pieces, the movable contact piece, and the auxiliary contact support in a housing portion formed of a first case member and a second case member.

Note that side-on type auxiliary contact units are disclosed in PTLs 1 and 2.

### CITATION LIST

### Patent Literature

PTL 1: JP 2011-141963 A

PTL 2: JP 2012-038644 A

### SUMMARY OF INVENTION

The unit case of the auxiliary contact unit is produced by, with joining portions of the respective ones of the first and second case members opposed to each other, pressure-connecting the joining portions of the respective ones of the first and second case members to each other by fastening force exerted by a fastening member, such as a bolt.

However, since the first and second case members are molded products that are formed by injecting insulating resin into a mold, the joining portions of the respective ones thereof are not necessarily flat and there have sometimes been cases where a gap was formed when the joining portions of the respective ones of the first and second case members were opposed to each other. Since such a gap serves as a passing route through which extraneous material, such as dirt and dust, invades the housing portion of the unit case from the outside, and, when insulating extraneous material that has invaded attaches to fixed contacts of the fixed contact pieces or movable contacts of the movable contact pieces, the extraneous material becomes a factor inviting a contact failure, there has been room for improvement from a viewpoint of reliability.

An object of the present invention is to provide a technology capable of increasing reliability of an auxiliary contact unit.

In order to achieve the above-described object, according to an aspect of the present invention, there is provided an auxiliary contact unit including: a pair of fixed contact pieces; a movable contact piece arranged in a contactable and separable manner to and from the pair of fixed contact pieces; an auxiliary contact support configured to hold the movable contact piece and move in conjunction with opening/closing operation of an electromagnetic contactor; and a unit case configured to house the pair of fixed contact pieces, the movable contact piece, and the auxiliary contact support in a housing portion formed with joining portions of respective ones of a first case member and a second case member opposed to each other. The joining portions of the respective ones of the first and second case members are air-tightly joined to each other.

According to the present invention, it is possible to increase reliability of an auxiliary contact unit.

### BRIEF DESCRIPTION OF DRAWINGS

FIG. 1 is a perspective view illustrative of a state in which an auxiliary contact unit according to a first embodiment of the present invention is attached to a side surface of an electromagnetic contactor;

FIG. 2 is a cross-sectional view illustrative of an internal structure of the electromagnetic contactor that is in a released state;

FIG. 3 is a cross-sectional view illustrative of the internal structure of the electromagnetic contactor that is in the released state and an internal structure of the auxiliary contact unit;

FIG. 4 is a cross-sectional view illustrative of the internal structure of the auxiliary contact unit when the electromagnetic contactor is in the released state;

FIG. 5 is a cross-sectional view illustrative of an internal structure of the electromagnetic contactor that is in a closed state and an internal structure of the auxiliary contact unit;

FIG. 6 is another cross-sectional view illustrative of the internal structure of the electromagnetic contactor that is in the closed state and the internal structure of the auxiliary contact unit;

FIG. 7 is a cross-sectional view illustrative of the internal structure of the auxiliary contact unit when the electromagnetic contactor is in the closed state;

FIG. 8 is a perspective view of the auxiliary contact unit;

FIG. 9 is an exploded perspective view of the auxiliary contact unit;

FIG. 10 is a cross-sectional view of the auxiliary contact unit;

FIG. 11 is an enlarged cross-sectional view enlarging a portion of FIG. 10;

FIG. 12 is a perspective view of an auxiliary contact support incorporated into the auxiliary contact unit;

FIG. 13 is another exploded perspective view of the auxiliary contact unit;

FIG. 14 is an exploded perspective view enlarging a portion of FIG. 13;

FIG. 15 is a cross-sectional view of a main part illustrative of a variation of the first embodiment of the present invention; and

FIG. 16 is an exploded perspective view of an auxiliary contact unit according to a second embodiment of the present invention.

### DETAILED DESCRIPTION

Embodiments of the present invention will now be described in detail with reference to the drawings.

Note that, in all the drawings for descriptions of examples of the present invention, the same reference signs are assigned to constituent components having the same functions and overlapping descriptions thereof will be omitted.

In addition, the respective drawings are schematic and do not necessarily depict actual implementation of the present invention. Further, the embodiments, which will be described below, indicate a device and a method to embody the technical idea of the present invention by way of example, and do not limit the configuration to that described below. That is, the technical idea of the present invention can be subjected to a variety of alterations within the technical scope described in CLAIMS.

In addition, in the following embodiments, it is assumed that, among three directions that are orthogonal to one another in a space, a first direction and a second direction that are orthogonal to each other in an identical plane are the X-direction and the Y-direction, respectively and a third direction that is orthogonal to each of the first direction and the second direction is the Z-direction. The following embodiments will be described, defining a direction in which an auxiliary contact support of an auxiliary contact unit moves to be the Z-direction.

### First Embodiment

In this first embodiment, an example in which the present invention is applied to a side-on type auxiliary contact unit will be described.

### Attachment Position of Auxiliary Contact Unit

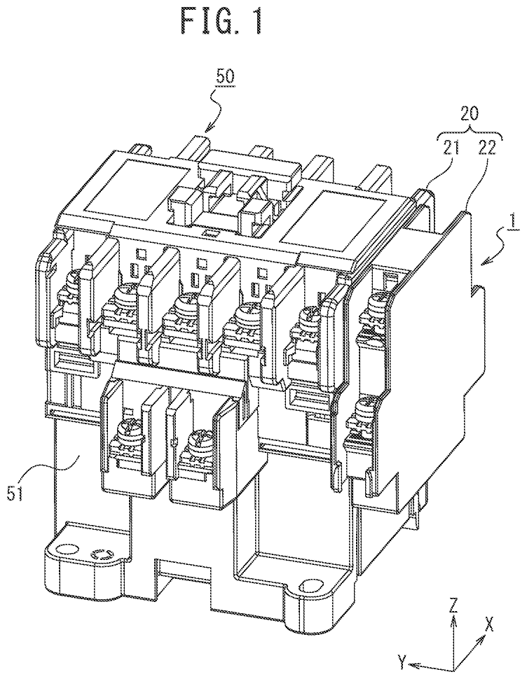

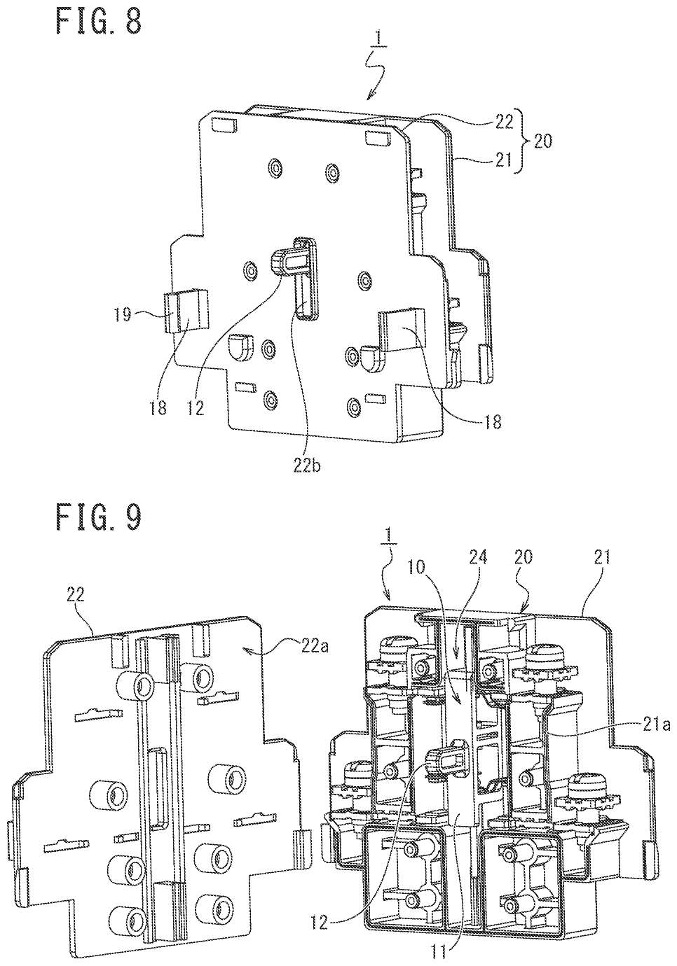

First, an attachment position of an auxiliary contact unit 1 according to the first embodiment of the present invention will be described with reference to FIGS. 1 and 8.

As illustrated in FIG. 1, the auxiliary contact unit 1 according to the first embodiment of the present invention is attached to a side surface of a body case 51 of an electromagnetic contactor 50 in a freely attachable/detachable manner. The attachment of the auxiliary contact unit 1 is performed by engaging engagement portions 19 formed on hooks 18 of a unit case 20 of the auxiliary contact unit 1 (see FIG. 8) with engagement receiving portions (not illustrated) formed on the body case 51 of the electromagnetic contactor 50.

### Configuration of Electromagnetic Contactor

Next, a configuration of the electromagnetic contactor 50 will be described with reference to FIGS. 1 to 3.

As illustrated in FIGS. 1 to 3, the electromagnetic contactor 50 includes the body case 51, contact units 60 configured to perform opening and closing of an electrical circuit, and an electromagnet unit 70 configured to drive the contact units 60. The contact units 60 and the electromagnet unit 70 that are arranged in series in the Z-direction are housed in the body case 51. The electromagnetic contactor 50 is a contactor that opens and closes a three-phase AC circuit.

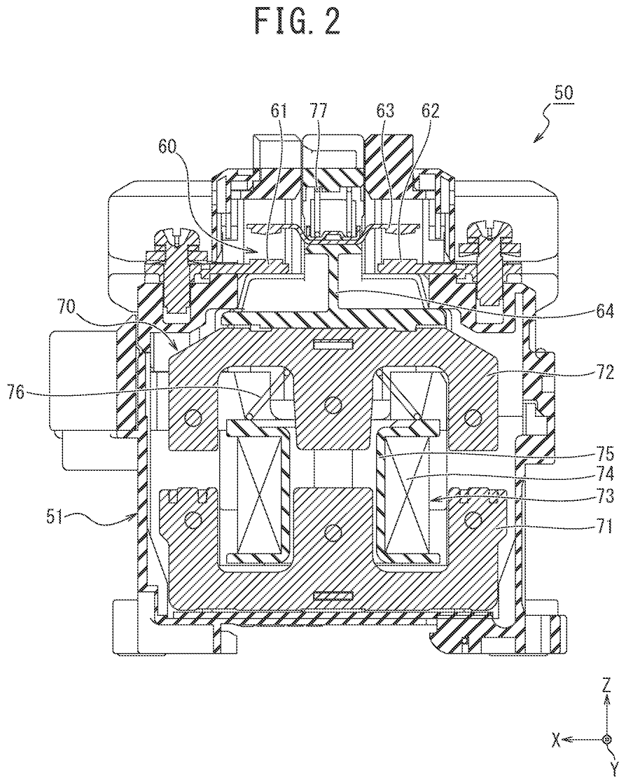

As illustrated in FIG. 2, each of the contact units 60 includes a pair of fixed contact pieces 61 and 62, a bridge type movable contact piece 63 that is arranged in a contactable and separable manner to and from the pair of fixed contact pieces 61 and 62, and a movable contact support 64 configured to hold the movable contact piece 63.

Each contact piece of each of the pairs of fixed contact pieces 61 and 62 extends in the X-direction and has a fixed contact formed on one end side and an external terminal portion formed on the other end side. Each of the pairs of fixed contact pieces 61 and 62 are fixed to the body case 51 with the one end sides of the respective ones thereof opposed to each other and separated from each other in the X-direction.

Each of the movable contact pieces 63 extends in the X-direction and has movable contacts respectively formed on one end side and the other end side. The movable contact on the one end side of the movable contact piece 63 and the fixed contact of the one fixed contact piece 61 are arranged in such a manner as to face each other. The movable contact on the other end side of the movable contact piece 63 and the fixed contact of the other fixed contact piece 62 are arranged in such a manner as to face each other. The movable contact pieces 63 are held by the movable contact support 64. Each of the pairs of fixed contact pieces 61 and 62 and a corresponding movable contact piece 63 constitute a contact portion, and three contact portions of this type are arranged in line in the Y-direction in a corresponding manner to the three-phase AC circuit.

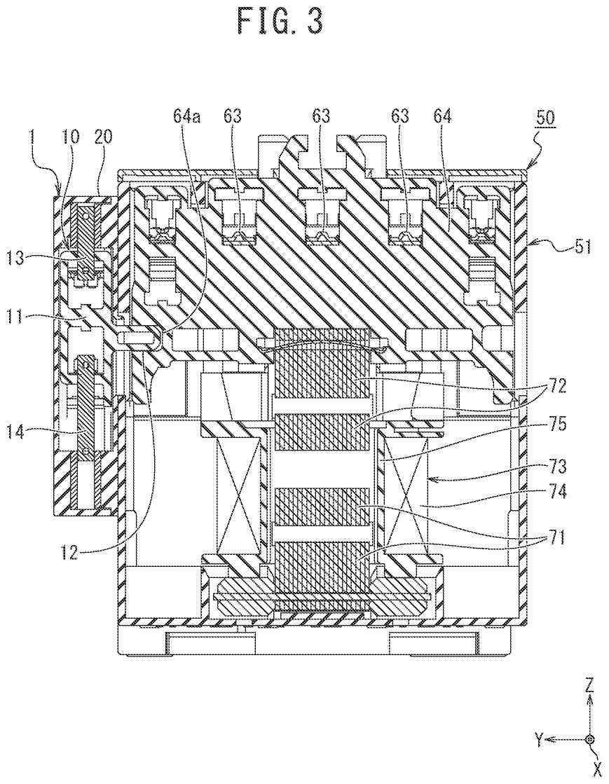

As illustrated in FIGS. 2 and 3, the electromagnet unit 70 includes a fixed iron core 71 and a movable iron core 72, an electromagnetic coil 73, and a return spring 76. The fixed iron core 71 and the movable iron core 72 are arranged in such a manner that pole contact surfaces of the respective ones thereof are opposed to each other.

The electromagnetic coil 73 generates magnetic field that causes the fixed iron core 71 and the movable iron core 72 to be attracted and stuck to each other due to electromagnetic force. The electromagnetic coil 73 includes a winding 74 and a bobbin 75. The winding 74 passes through interspaces between a central leg portion and outer-side leg portions of each of the fixed iron core 71 and the movable iron core 72 and goes around the central leg portion. The bobbin 75 is a component around which the winding 74 is wound. The bobbin 75 includes a cylindrical portion on the inner diameter side of which the central leg portions of the respective ones of the fixed iron core 71 and the movable iron core 72 are inserted and on the outer diameter side of which the winding 74 is wound around. In addition, on the bobbin 75, flange portions that project from both ends of the cylindrical portion to the outer diameter side thereof in a flange shape are formed.

The return spring 76 is a biasing means for biasing the movable iron core 72 in a direction in which the movable iron core 72 moves away from the fixed iron core 71. The return spring 76 is, for example, a coil spring disposed across an interspace between the upper surface of the bobbin 75 of the electromagnetic coil 73 and the movable iron core 72

Each of the pairs of fixed contact pieces 61 and 62 and a corresponding movable contact piece 63 are an electrical contact configured to switch connection and disconnection of a circuit by coming into contact with and going away from each other.

As illustrated in FIG. 2, each of the movable contact pieces 63 is fixed to one end side in the Z-direction of the movable contact support 64. The other end side in the Z-direction of the movable contact support 64 is fixed to the back surface side of the movable iron core 72 on the opposite side to the leg portion side thereof. The movable contact piece 63 moves in the Z-direction in conjunction with movement in the Z-direction of the movable iron core 72. That is, the pairs of fixed contact pieces 61 and 62 and the corresponding movable contact pieces 63 move away from each other in a released state in which the pair of the fixed iron core 71 and the movable iron core 72 are separated from each other and come into contact with each other in a closed state in which the fixed iron core 71 and the movable iron core 72 are in contact with each other.

On the opposite side to the movable iron core 72 side of each of the movable contact pieces 63, a contact spring 77 is disposed.

### Configuration of Auxiliary Contact Unit

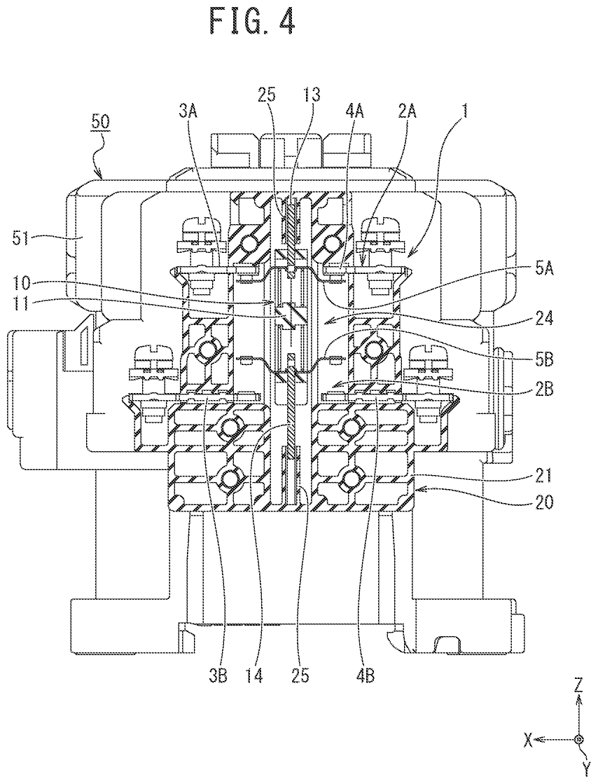

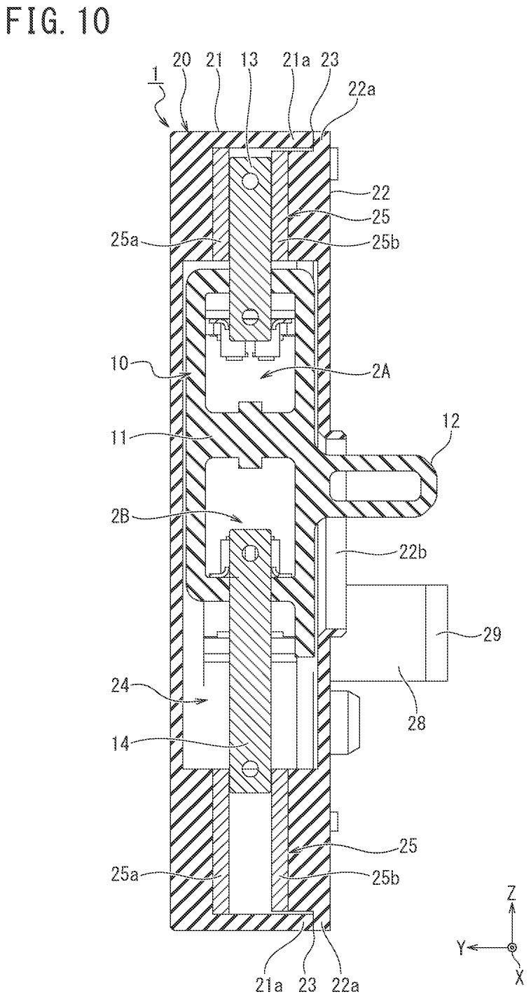

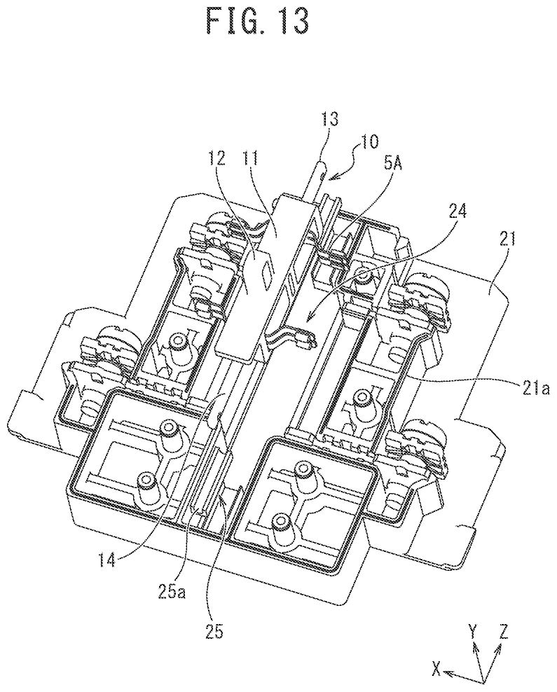

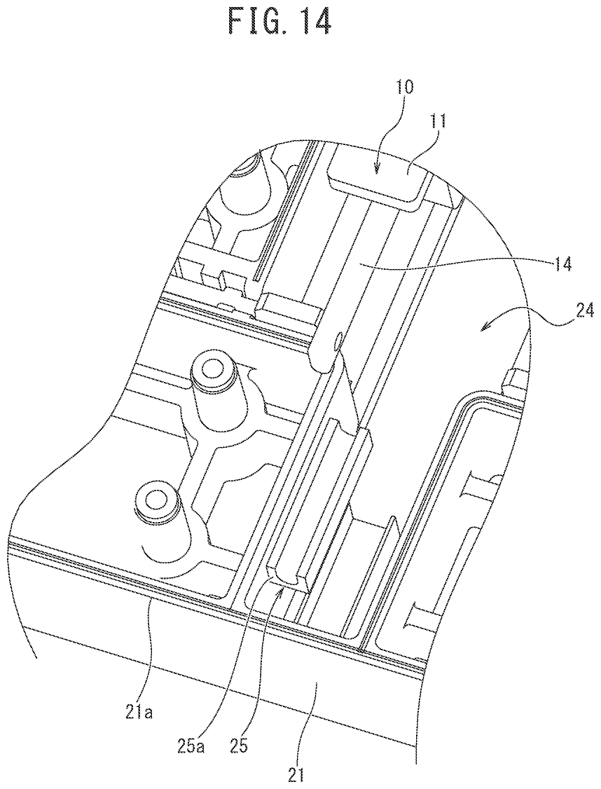

Next, a configuration of the auxiliary contact unit 1 according to the first embodiment of the present invention will be described with reference to FIGS. 4 and 8 to 13.

As illustrated in FIG. 4, the auxiliary contact unit 1 includes a first contact portion 2A and a second contact portion 2B. The first contact portion 2A includes a pair of fixed contact pieces 3A and 4A and a bridge type movable contact piece 5A that is arranged in a contactable and separable manner to and from the pair of fixed contact pieces 3A and 4A. Likewise, the second contact portion 2B includes a pair of fixed contact pieces 3B and 4B and a movable contact piece 5B that is arranged in a contactable and separable manner to and from the pair of fixed contact pieces 3B and 4B.

As illustrated in FIGS. 4, 9, and 10, the auxiliary contact unit 1 includes an auxiliary contact support (auxiliary contact holder) 10 configured to hold the movable contact piece 5A of the first contact portion 2A and the movable contact piece 5B of the second contact portion 2B and move in the Z-direction in conjunction with the opening/closing operation of the electromagnetic contactor 50.

In addition, as illustrated in FIGS. 4 and 8 to 10, the auxiliary contact unit 1 includes a first case member 21 and a second case member 22 and includes, in a housing portion 24 that is formed with joining portions 21a and 22a of the respective ones of the first case member 21 and the second case member 22 opposed to each other, the unit case 20 configured to house the first contact portion 2A, the second contact portion 2B, the auxiliary contact support 10, and the like.

As illustrated in FIG. 4, the first contact portion 2A and the second contact portion 2B are arranged in two stages in the movement direction (Z-direction) of the auxiliary contact support 10. The first contact portion 2A is arranged above the second contact portion 2B.

In the first contact portion 2A, each of the pair of fixed contact pieces 3A and 4A extends in the X-direction and has a fixed contact formed on one end side and an external terminal portion formed on the other end side, as illustrated in FIG. 4. The pair of fixed contact pieces 3A and 4A are fixed to the unit case 20 with the one end sides of the respective ones thereof opposed to each other and separated from each other in the X-direction. The movable contact piece 5A extends in the X-direction and has movable contacts respectively formed on one end side and the other end side. The movable contact on the one end side of the movable contact piece 5A and the fixed contact of the one fixed contact piece 3A are arranged in such a manner as to face each other. The movable contact on the other end side of the movable contact piece 5A and the fixed contact of the other fixed contact piece 4A are arranged in such a manner as to face each other.

In the second contact portion 2B, each of the pair of fixed contact pieces 3B and 4B extends in the X-direction and has a fixed contact formed on one end side and an external terminal portion formed on the other end side, as illustrated in FIG. 4. The pair of fixed contact pieces 3B and 4B are fixed to the unit case 20 with the one end sides of the respective ones thereof opposed to each other and separated from each other in the X-direction. The movable contact piece 5B extends in the X-direction and has movable contacts respectively formed on one end side and the other end side. The movable contact on the one end side of the movable contact piece 5B and the fixed contact of the one fixed contact piece 3B are arranged in such a manner as to face each other. The movable contact on the other end side of the movable contact piece 5B and the fixed contact of the other fixed contact piece 4B are arranged in such a manner as to face each other.

Each of the pair of fixed contact pieces 3A and 4A, the movable contact piece 5A, the pair of fixed contact pieces 3B and 4B, and the movable contact piece 5B is formed of, for example, a flat plate-shaped conductive plate made of metal.

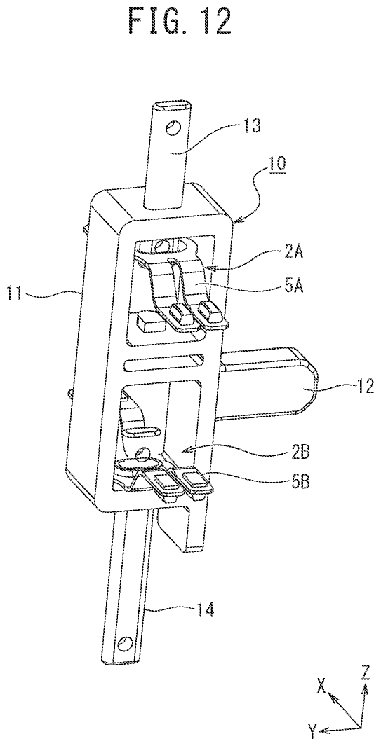

As illustrated in FIG. 12, the auxiliary contact support 10 includes a body portion 11 holding the movable contact piece 5A of the first contact portion 2A and the movable contact piece 5B of the second contact portion 2B and a coupling protrusion 12 that is integrally formed with the body portion 11 on a side surface of the body portion 11 and that protrudes from the side surface of the body portion 11 in the Y-direction. The auxiliary contact support 10 also includes a rod-shaped first sliding guide piece 13 and second sliding guide piece 14 that are respectively formed on both sides in the longitudinal direction (Z-direction) of the body portion 11 in a connected manner and that extend in the longitudinal direction of the body portion 11. The body portion 11 and the coupling protrusion 12 are formed of, for example, an epoxy-based thermosetting insulating resin, and the first sliding guide piece 13 and the second sliding guide piece 14 are formed of a conductive material. Examples of the conductive material include, without being limited to, a metallic material, such as aluminum and copper.

As illustrated in FIGS. 8 to 10, the coupling protrusion 12 is inserted through an elongated opening 22b that is formed on the second case member 22 of the unit case 20, projects to the outside, and moves in the direction of motion of the auxiliary contact support 10 while being inserted through the elongated opening 22b. As illustrated in FIG. 3, when the auxiliary contact unit 1 is attached to a side surface of the body case 51 of the electromagnetic contactor 50, the coupling protrusion 12 of the auxiliary contact support 10 is inserted into a recessed portion 64a formed on the movable contact support 64 of the electromagnetic contactor 50 and is thereby coupled to the movable contact support 64. That is, the auxiliary contact support 10 of the auxiliary contact unit 1 moves in the Z-direction in conjunction with the opening/closing operation of the electromagnetic contactor 50.

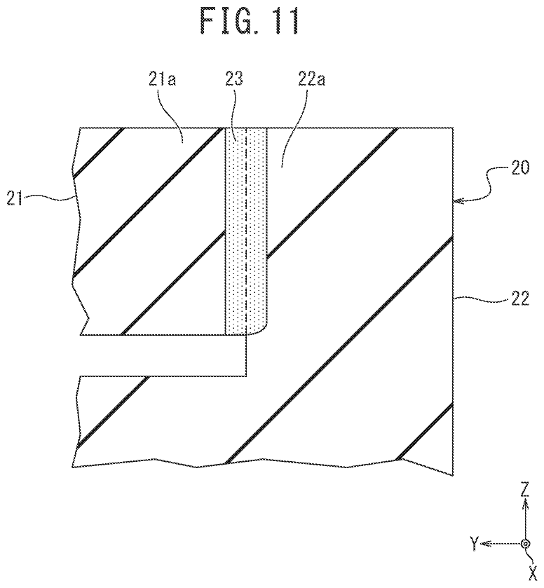

As illustrated in FIGS. 10 and 11, the joining portion 21a of the first case member 21 and the joining portion 22a of the second case member 22 are opposed to each other in a direction (Y-direction) orthogonal to the direction of motion (Z-direction) of the auxiliary contact support 10. The joining portions 21a and 22a of the respective ones of the first case member 21 and the second case member 22 are air-tightly joined to each other. In the first embodiment, the joining portions 21a and 22a of the respective ones of the first case member 21 and the second case member 22 are air-tightly joined to each other by means of welding. Therefore, as illustrated in FIG. 11, a welded portion 23 is formed at the joining portions 21a and 22a of the respective ones of the first case member 21 and the second case member 22. Methods for air-tight joining by means of welding include a method of welding the respective joining portions 21a and 22a by means of laser irradiation, a method of welding the joining portions 21a and 22a by means of thermocompression bonding, and the like. In the first embodiment, the joining portions 21a and 22a of the respective ones of the first case member 21 and the second case member 22 are air-tightly joined to each other by means of thermocompression bonding.

The unit case 20 is formed by assembling the first case member 21 and the second case member 22, which are separate components, together. Specifically, with the joining portions 21a and 22a of the respective ones of the first case member 21 and the second case member 22 opposed to each other, the first case member 21 and the second case member 22 are fastened and fixed to each other, using, for example, a fastening member. With the first case member 21 and the second case member 22 fastened and fixed to each other, the joining portions 21a and 22a of the respective ones of the first case member 21 and the second case member 22 are air-tightly joined by means of, for example, welding. The first and second case members 21 and 22 are molded components that are separately formed by injecting, for example, epoxy-based thermosetting insulating resin into a mold.

The first case member 21 includes a flat plate portion and a rib portion formed on one surface side of the flat plate portion. On the other hand, the second case member 22 is formed of a flat plate. The joining portion 21a of the first case member 21 is formed by the rib portion, and the joining portion 22a of the second case member 22 is formed by a portion of the flat plate that faces the rib portion of the first case member 21.

As illustrated in FIGS. 10, 13, and 14, the unit case 20 further includes two cylindrical guide rails 25 on which the first sliding guide piece 13 and the second sliding guide piece 14 of the auxiliary contact support 10 individually slide. The first sliding guide piece 13 slides on the inner peripheral surface of one of the guide rails 25 in the longitudinal direction (Z-direction) of the one of the guide rails 25, and the second sliding guide piece 14 slides on the inner peripheral surface of the other of the guide rails 25 in the longitudinal direction (Z-direction) of the other of the guide rails 25.

Each of the two guide rails 25 is composed of two divided pieces 25a and 25b into each of which a component is halved in a lateral direction orthogonal to the longitudinal direction, and one divided piece 25a is fixed to the first case member 21 and the other divided piece 25b is fixed to the second case member 22. The two pairs of divided pieces 25a and 25b constitute the guide rails 25 by joining the joining portions 21a and 22a of the respective ones of the first case member 21 and the second case member 22.

The auxiliary contact support 10 is housed in the housing portion 24 of the unit case 20 with the first and second sliding guide pieces 13 and 14 respectively supported by the cylindrical guide rails 25 in a freely slidable manner and the body portion 11 separated from the first case member 21 and the second case member 22.

### Operation of Electromagnetic Contactor and Auxiliary Contact Unit

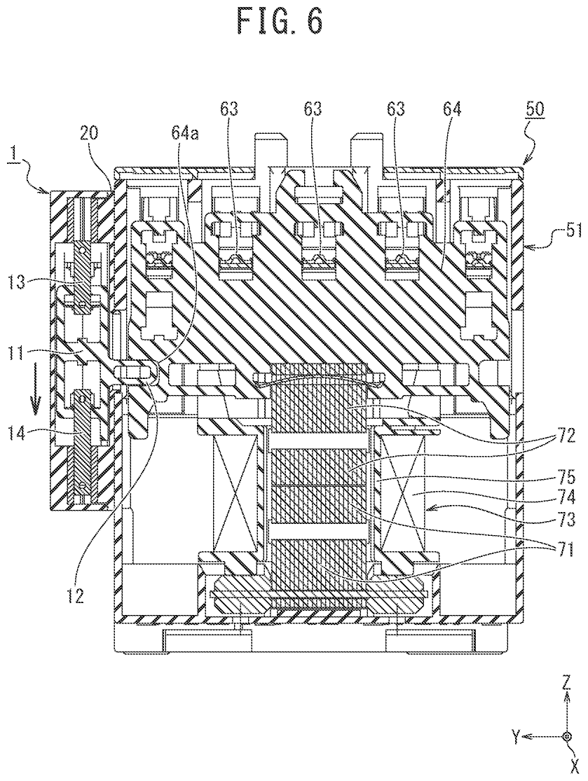

Next, referring to FIGS. 2 to 7, operation of the auxiliary contact unit 1, which is attached to the side surface of the body case of the electromagnetic contactor 50, will be described in conjunction with operation of the electromagnetic contactor 50.

First, it is assumed that the electromagnetic coil 73 of the electromagnetic contactor 50 is in a de-energized state (non-excited state) and the electromagnetic contactor 50 is in a non-operating state (see FIGS. 2 to 4). Since, in the de-energized state, the leg portions of the fixed iron core 71 do not generate an attractive force, the movable contact support 64 is biased in the backward direction (upward direction) in which the movable contact support 64 moves away from the fixed iron core 71, by the return spring 76. Thus, in each contact portion, the movable contact piece 63 is positioned at a location separated in the backward direction from the pair of fixed contact pieces 61 and 62, and the electromagnetic contactor 50 is brought to the released state.

When the electromagnetic contactor 50 is in the released state, the first contact portion 2A of the auxiliary contact unit 1 is in a closed electrode state (b-contact state) in which the movable contact piece 5A is in contact with the respective ones of the pair of fixed contact pieces 3A and 4A and the second contact portion 2B of the auxiliary contact unit 1 is in an open electrode state (a-contact state) in which the movable contact piece 5B is separated from the respective ones of the pair of fixed contact pieces 3B and 4B, as illustrated in FIG. 4.

When the electromagnetic contactor 50 that has been in the released state is brought to an operating state by energizing the electromagnetic coil 73 of the electromagnetic contactor 50, electromagnetic attractive force is generated on the leg portions and the pole contact surfaces of the fixed iron core 71. The movable iron core 72 being attracted to the fixed iron core 71 by the electromagnetic attractive force against the return spring 76 causes the movable contact support 64 to move forward toward the fixed iron core 71 and the movable contact pieces 63 held by the movable contact support 64 to move forward toward the pairs of fixed contact pieces 61 and 62.

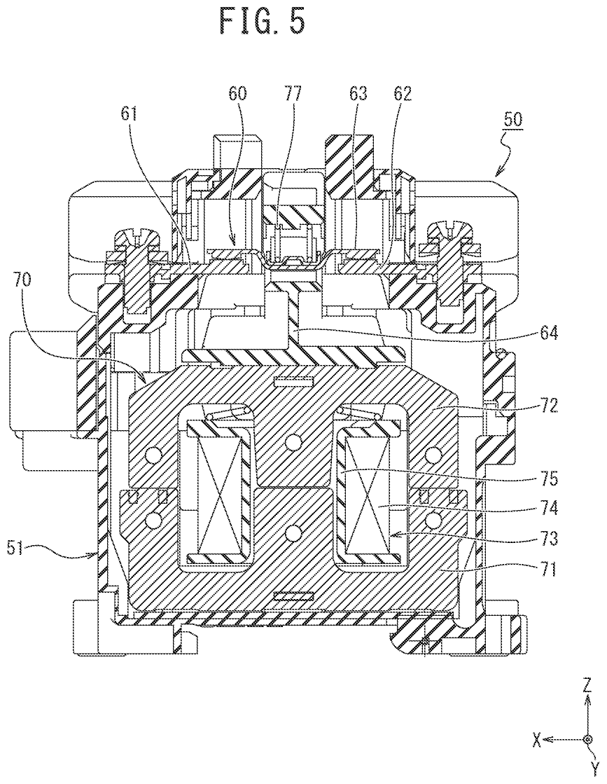

When, as illustrated in FIG. 5, the movable contact pieces 63 come into contact with the pairs of fixed contact pieces 61 and 62 and the electromagnetic contactor 50 is thereby brought to the closed state, the forward movement of the movable contact pieces 63 is stopped, but the forward movement of the movable contact support 64 is maintained. Thus, the contact springs 77 are compressed.

Subsequently, when the movable iron core 72 is attracted and stuck to the pole contact surfaces of the fixed iron core 71, the forward movement of the movable contact support 64 is stopped. In this state, the electromagnetic contactor 50 is brought to a completely closed state in which the movable contact pieces 63 are in contact with the pairs of fixed contact pieces 61 and 62 with a prescribed contact pressure by the contact springs 77. The completely closed state is maintained by attractive force between the movable iron core 72 and the fixed iron core 71.

While the electromagnetic contactor 50 transitions from the released state to the completely closed state, in the auxiliary contact unit 1, the auxiliary contact support 10 moves forward toward the lower side in conjunction with the forward movement of the movable contact support 64 of the electromagnetic contactor 50, which causes the movable contact piece 5A held by the auxiliary contact support 10 to move in a direction of moving away from the pair of fixed contact pieces 3A and 4A and, at the same time, the movable contact piece 5B held by the auxiliary contact support 10 to move in a direction of coming close to the pair of fixed contact pieces 3B and 4B. The movement of the auxiliary contact support 10 at this time is performed by the first sliding guide piece 13 and the second sliding guide piece 14 respectively sliding on the guide rails 25.

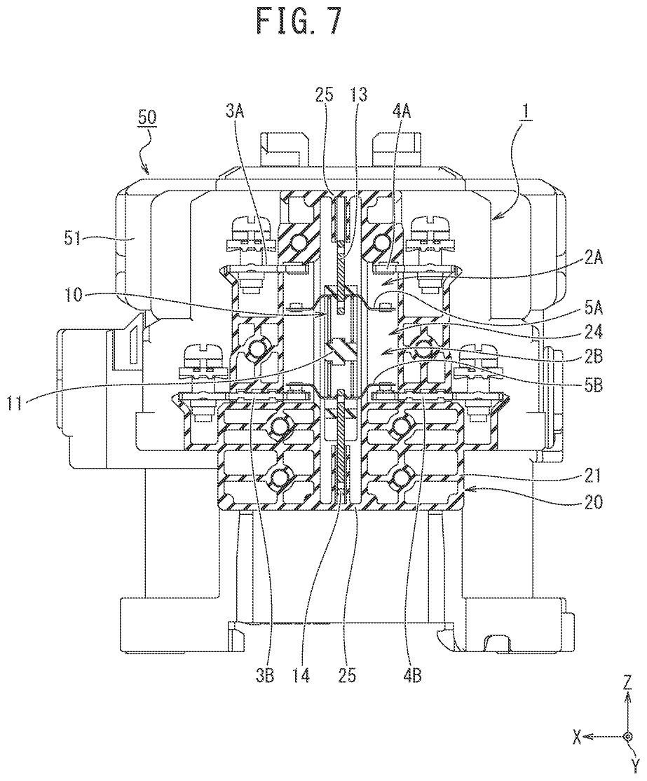

When the forward movement of the movable contact support 64 of the electromagnetic contactor 50 is stopped, the first contact portion 2A of the auxiliary contact unit 1 is brought to the open electrode state (a-contact state) in which the movable contact piece 5A is separated from the respective ones of the pair of fixed contact pieces 3A and 4A and the second contact portion 2B of the auxiliary contact unit 1 is brought to the closed electrode state (b-contact state) in which the movable contact piece 5B is in contact with the respective ones of the pair of fixed contact pieces 3B and 4B, as illustrated in FIG. 7. The open electrode state of the first contact portion 2A and the closed electrode state of the second contact portion 2B are maintained by the electromagnetic contactor 50 being maintained in the completely closed state.

When the energization of the electromagnetic coil 73 of the electromagnetic contactor 50 is cut off while the electromagnetic contactor 50 is in the completely closed state, disappearance of attractive force from the fixed iron core 71 of the electromagnetic contactor 50 causes the movable contact support 64 to move backward in a direction of moving away from the fixed iron core 71 due to elastic force of the return spring 76. Thus, the movable contact pieces 63 move backward away from the pairs of fixed contact pieces 61 and 62, and the electromagnetic contactor 50 returns to the released state. At this time, in the auxiliary contact unit 1, the auxiliary contact support 10 moves backward toward the upper side in conjunction with the backward movement of the movable contact support 64 of the electromagnetic contactor 50, which causes the movable contact piece 5A held by the auxiliary contact support 10 to move in a direction of coming close to the pair of fixed contact pieces 3A and 4A and, at the same time, the movable contact piece 5B held by the auxiliary contact support 10 to move in a direction of moving away from the pair of fixed contact pieces 3B and 4B. The movement of the auxiliary contact support 10 at this time is performed by the first sliding guide piece 13 and the second sliding guide piece 14 respectively sliding on the guide rails 25.

When the backward movement of the movable contact support 64 of the electromagnetic contactor 50 is stopped, the first contact portion 2A of the auxiliary contact unit 1 returns to the closed electrode state (b-contact state) in which the movable contact piece 5A is in contact with the respective ones of the pair of fixed contact pieces 3A and 4A and the second contact portion 2B of the auxiliary contact unit 1 returns to the open electrode state (a-contact state) in which the movable contact piece 5B is separated from the respective ones of the pair of fixed contact pieces 3B and 4B (see FIG. 4).

### Advantageous Effects of First Embodiment

Next, main advantageous effects of the first embodiment will be described.

A unit case of a conventional auxiliary contact unit is produced by, with joining portions of the respective ones of first and second case members opposed to each other, pressure-connecting the first and second case members to each other by fastening force exerted by a fastening member, such as a bolt. The first and second case members are molded products that are individually formed by injecting insulating resin into a mold, and the joining portions of the respective ones of the first and second case members are not necessarily flat. Thus, there have sometimes been cases where, when the joining portions of the respective ones of the first and second case members were opposed to each other, a gap was formed. Such a gap serves as a passing route through which extraneous material, such as dirt and dust, invades a housing portion of the unit case from the outside, and, when insulating extraneous material that has invaded attaches to a contact portion of a fixed contact piece or a movable contact piece, the extraneous material becomes a factor inviting a contact failure.

In contrast, the auxiliary contact unit 1 of the first embodiment has the joining portions 21a and 22a of the respective ones of the first case member 21 and the second case member 22 air-tightly joined to each other by means of welding. Thus, since, even when a gap is formed when the joining portions 21a and 22a of the respective ones of the first case member 21 and the second case member 22 are opposed to each other, the gap is closed by the air-tight joining, it is possible to prevent extraneous material, such as dirt and dust, from invading the housing portion 24 of the unit case 20 from the outside through the joining portions 21a and 22a of the respective ones of the first case member 21 and the second case member 22. As a result, it is possible to suppress contact failure occurring between the pair of fixed contact pieces 3A and 4A and the movable contact piece 5A of the first contact portion 2A and contact failure occurring between the pair of fixed contact pieces 3B and 4B and the movable contact piece 5B of the second contact portion 2B, caused by insulating extraneous material that has invaded the housing portion 24 of the unit case 20 from the outside attaching to the fixed contacts of the fixed contact pieces 3A, 4A, 3B, and 4B and the movable contacts of the movable contact pieces 5A and 5B. Therefore, the first embodiment enables the auxiliary contact unit 1 that has higher reliability than a conventional auxiliary contact unit to be provided.

In addition, the conventional auxiliary contact unit is configured such that a body portion of an auxiliary contact support slides on guide portions that are respectively formed on the first and second case members in such a manner as to face each other. The guide portions of the respective ones of the first and second case members and the body portion of the auxiliary contact support are formed of an insulating resin. Thus, when the body portion of the auxiliary contact support is moved a large number of times, the guide portions of the case members and the body portion of the auxiliary contact support are worn and wear fragments from the wear attach to the fixed contacts of the fixed contact pieces and the movable contacts of the movable contact pieces as insulating extraneous material, which becomes a factor inviting contact failure between the fixed contact pieces and the movable contact pieces.

In contrast, in the auxiliary contact unit 1 of the first embodiment, the first and second sliding guide pieces 13 and 14 of the auxiliary contact support 10 and the two guide rails 25 are formed of a conductive material. Thus, wear fragments generated by wear of the first and second sliding guide pieces 13 and 14 of the auxiliary contact support 10 and wear of the two guide rails 25 when the first and second sliding guide pieces 13 and 14 of the auxiliary contact support 10 are moved a large number of times are conductive extraneous material, and, even when the conductive extraneous material attaches to the fixed contacts of the fixed contact pieces 3A, 4A, 3B, and 4B and the movable contacts of the movable contact pieces 5A and 5B, it is possible to reduce a factor inviting contact failure occurring between the pair of fixed contact pieces 3A and 4A and the movable contact piece 5A of the first contact portion 2A and contact failure occurring between the pair of fixed contact pieces 3B and 4B and the movable contact piece 5B of the second contact portion 2B. As a result, the auxiliary contact unit 1 of the first embodiment enables contact failure occurring between the pair of fixed contact pieces 3A and 4A and the movable contact piece 5A of the first contact portion 2A and contact failure occurring between the pair of fixed contact pieces 3B and 4B and the movable contact piece 5B of the second contact portion 2B caused by extraneous material that has been generated in the housing portion 24 of the unit case 20 to be suppressed.

### Variation

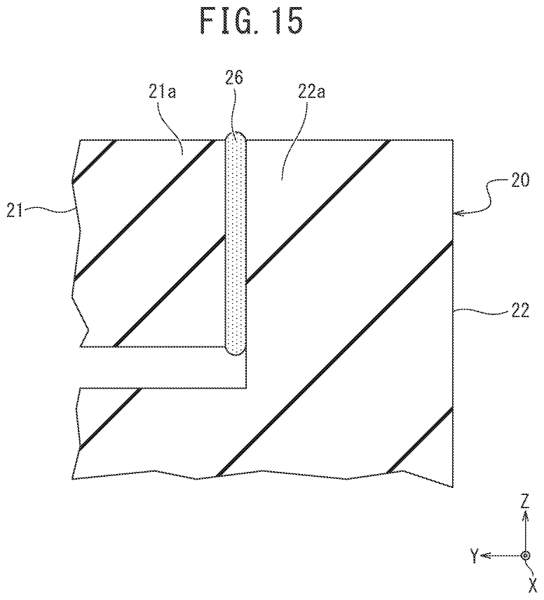

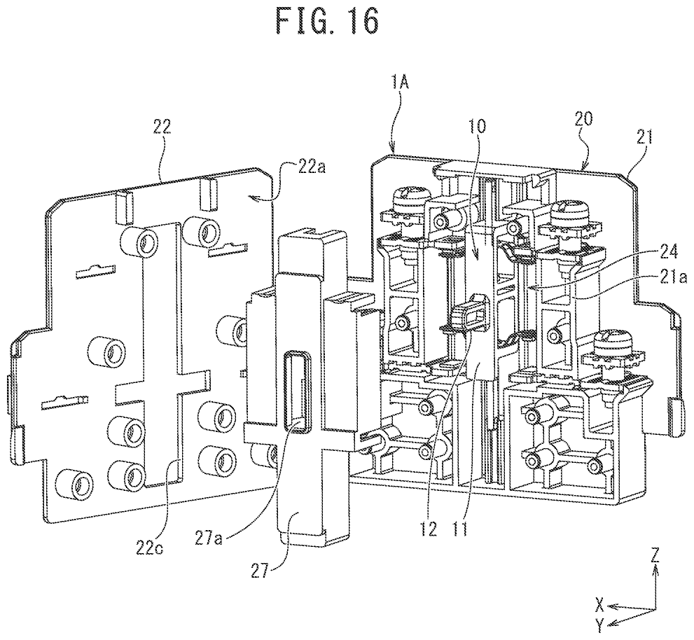

In the above-described first embodiment, a configuration in which the joining portions 21a and 22a of the respective ones of the first case member 21 and the second case member 22 are air-tightly joined to each other by means of welding was described. However, the present invention is not limited to the air-tight joining by means of welding. For example, as illustrated in FIG. 15, the joining portions 21a and 22a of the respective ones of the first case member 21 and the second case member 22 may be air-tightly joined by means of an adhesive material 26.

### Second Embodiment

An auxiliary contact unit 1A according to a second embodiment of the present invention basically has the similar configuration as the auxiliary contact unit 1 according to the above-described first embodiment except the following configuration.

That is, as illustrated in FIG. 16, the auxiliary contact unit 1A of the second embodiment includes a cover member 27 that is fixed to a first case member 21 in such a manner as to cover an auxiliary contact support 10, in a housing portion 24 of a unit case 20. The cover member 27 has an elongated opening 27a through which a coupling protrusion 12 of the auxiliary contact support 10 penetrates. A second case member 22 has a cross-shaped through-hole 22c through which a portion of the cover member 27 is inserted, in place of the elongated opening 22b of the first embodiment. The coupling protrusion 12 of the auxiliary contact support 10 is inserted through the elongated opening 27a of the cover member 27 and the through-hole 22c of the second case member 22 and projects to the outside of the unit case 20.

The auxiliary contact unit 1A of the second embodiment includes the cover member 27, as described above. Therefore, the auxiliary contact unit 1A according to the second embodiment enables extraneous material that has invaded the housing portion 24 of the unit case 20 from the outside to be suppressed from attaching to fixed contacts of fixed contact pieces (3A, 4A, 3B, and 4B) and movable contacts of movable contact pieces 5A and 5B, using the cover member. The second embodiment enables the auxiliary contact unit 1A that has higher reliability than a conventional auxiliary contact unit to be provided.

Note that, although the second embodiment enables the auxiliary contact unit 1A having high reliability to be acquired without air-tightly joining the first case member 21 and the second case member 22 as in the above-described first embodiment, air-tightly joining the first case member 21 and the second case member 22 as in the above-described first embodiment enables the reliability to be further increased.

In addition, although joining portions of the respective ones of the cover member 27 and the first case member 21 do not have to be air-tightly joined, the joining portions may be air-tightly joined by means of welding as in the above-described first embodiment or may be air-tightly joined by means of an adhesive material as in the above-described variation.

Note that, in the above-described second embodiment, a configuration in which the cover member 27 is fixed to the first case member 21 was described. However, the present invention is not limited to the fixing of the cover member 27 to the first case member 21. For example, the cover member 27 may be fixed to the second case member 22 or may be fixed to both the first case member 21 and the second case member 22. In sum, the cover member 27 is only required to be fixed to at least either the first case member 21 or the second case member 22 in such a manner as to cover the auxiliary contact support 10.

In addition, in the first and second embodiments, a case where the first and second sliding guide pieces 13 and 14 and the two guide rails 25 are formed of a conductive material was described. However, the present invention is not limited to the case where both the sliding guide pieces (13 and 14) and the guide rails 25 are formed of a conductive material. For example, at least either the sliding guide pieces (13 and 14) or the guide rails 25 may be formed of a conductive material. In addition, at least either the first sliding guide piece 13 or the second sliding piece 14 may be formed of a conductive material, and at least either of the two guide rails 25 may be formed of a conductive material. In sum, it is only required that the amount of insulating extraneous material generated inside the housing portion 24 of the unit case 20 becomes smaller than a conventional configuration.

In addition, although, in the above-described first and second embodiments, a configuration in which a rib is formed on the first case member 21 was described, the present invention is not limited to the case where a rib is formed on the first case member 21. The present invention is applicable to a configuration in which a rib is formed on the second case member 22 and a configuration in which ribs are formed on both the first and second case members.

Recent years, cases of use of an electromagnetic contactor in a severe environment have increased, and it has become necessary that an auxiliary contact unit that is an attachment to an electromagnetic contactor has environmental resistance performance (dust resistance) that can withstand use in a severe environment. Therefore, the auxiliary contact unit of the present invention is useful for use in a severe environment.

Although the present invention was specifically described above, based on the above-described embodiments and variation, the present invention is not limited to the above-described embodiments and variation, and it is needless to say that the present invention can be embodied with various modifications without departing from the scope of the present invention.

### REFERENCE SIGNS LIST

1, 1A Auxiliary contact unit

2A First contact portion

2B Second contact portion

3A, 3B, 4A, 4B Fixed contact piece

5A, 5B Movable contact piece

10 Auxiliary contact support

11 Body portion

12 Coupling protrusion

13 First sliding guide piece

14 Second sliding guide piece

20 Unit case

21 First case member

21a Joining portion

22 Second case member

22a Joining portion

22b Elongated opening

23 Welded portion

24 Housing portion

25 Guide rail

26 Adhesive material

27 Cover member

50 Electromagnetic contactor

51 Body case

60 Contact unit

61, 62 Fixed contact piece

63 Movable contact piece

64 Movable contact support

70 Electromagnet unit

71 Fixed iron core

72 Movable iron core

73 Electromagnetic coil

74 Winding

75 Bobbin

76 Return spring

77 Contact spring

1. An auxiliary contact unit comprising:
a pair of fixed contact pieces;
a movable contact piece arranged in a contactable and separable manner to and from the pair of fixed contact pieces;
an auxiliary contact support configured to hold the movable contact piece and move in conjunction with opening/closing operation of an electromagnetic contactor; and
a unit case configured to house the pair of fixed contact pieces, the movable contact piece, and the auxiliary contact support in a housing portion formed with joining portions of respective ones of a first case member and a second case member opposed to each other, the unit case being arranged outside a body case of the electromagnetic contactor, wherein
the joining portions of the respective ones of the first and second case members are air-tightly joined to each other.

2. The auxiliary contact unit according to claim 1, wherein the joining portions of the respective ones of the first and second case members are air-tightly joined to each other by means of welding.

3. The auxiliary contact unit according to claim 1, wherein the joining portions of the respective ones of the first and second case members are air-tightly joined to each other by means of an adhesive material.

4. The auxiliary contact unit according to claim 1, wherein
the auxiliary contact support has sliding guide pieces respectively on both sides in an axial direction,
the unit case has guide rails on which the sliding guide pieces slide, and
at least either the sliding guide pieces or the guide rails are formed of a conductive material.

5. The auxiliary contact unit according to claim 1, wherein the first and second case members are formed of an insulating resin.

6. An auxiliary contact unit comprising:
a pair of fixed contact pieces;
a movable contact piece arranged in a contactable and separable manner to and from the pair of fixed contact pieces;
an auxiliary contact support configured to hold the movable contact piece and move in conjunction with opening/closing operation of an electromagnetic contactor;
a unit case configured to house the pair of fixed contact pieces, the movable contact piece, and the auxiliary contact support in a housing portion formed with joining portions of respective ones of a first case member and a second case member opposed to each other, the unit case being arranged outside a body case of the electromagnetic contactor; and
a cover member fixed to at least either the first case member or the second case member in such a manner as to cover the auxiliary contact support.

7. The auxiliary contact unit according to claim 6, wherein
the auxiliary contact support has sliding guide pieces respectively on both sides in an axial direction,
the unit case has guide rails on which the sliding guide pieces slide, and
at least either the sliding guide pieces or the guide rails are formed of a conductive material.

8. The auxiliary contact unit according to claim 6, wherein the first and second case members are formed of an insulating resin.

9. The auxiliary contact unit according to claim 2, wherein
the auxiliary contact support has sliding guide pieces respectively on both sides in an axial direction,
the unit case has guide rails on which the sliding guide pieces slide, and
at least either the sliding guide pieces or the guide rails are formed of a conductive material.

10. The auxiliary contact unit according to claim 3, wherein
the auxiliary contact support has sliding guide pieces respectively on both sides in an axial direction,
the unit case has guide rails on which the sliding guide pieces slide, and
at least either the sliding guide pieces or the guide rails are formed of a conductive material.

11. The auxiliary contact unit according to claim 2, wherein the first and second case members are formed of an insulating resin.

12. The auxiliary contact unit according to claim 3, wherein the first and second case members are formed of an insulating resin.

13. The auxiliary contact unit according to claim 7, wherein the first and second case members are formed of an insulating resin.
